(19) United States
(12) Patent Application Publication
(10) Pub. No.: US 2016/0178826 A1
(43) Pub. Date: Jun. 23, 2016

(54) Lighting Device

(71) Applicant: VALEO SYSTEMES THERMIQUES, Le Mesnil Saint Dénis (FR)

(72) Inventors: Maryline THORAILLER, Le Mesnil Saint Dénis (FR); Stéphane BOMBARD, Le Mesnil Saint Dénis (FR)

(21) Appl. No.: 14/907,446

(22) PCT Filed: Jul. 24, 2014
(86) PCT No.: PCT/FR2014/000176

§ 371 Date: Jan. 25, 2016

(30) Foreign Application Priority Data
Jul. 25, 2013 (FR) 1301790

(51) Int. Cl. F21V 8/00; B60Q 3/02; B60Q 3/00

(52) U.S. Cl. CPC G02B 6/0006; B60Q 3/004; B60Q 3/024

(57) ABSTRACT

The invention relates to a lighting device (10) including: at least one light source (12); a light collector (14); two light-gathering guides (16, 18) associated with the light collector (14), characterized in that the light collector (14) is shaped such as to lead a light beam from said at least one light source (12) into the two light-gathering guides (16, 18); each one of said gathering guides is provided with an input end (161, 181) that tangentially penetrates the light collector (14), and with an output end (162, 182); and the two gathering guides (16, 18) are shaped such that the output ends (162, 182) come together, forming an output diopter of the lighting device.

The present invention relates to a lighting device, particularly for a motor vehicle. The invention also relates to an indicator light comprising a lighting device according to the invention and to a motor vehicle control panel comprising a lighting device according to the invention.

The number of lighting devices present in the passenger compartment of a motor vehicle increases with the sophistication of the vehicles. Some of these lighting devices are to be rotated by the user. This type of rotating lighting device generally comprises a light index. This light index generally allows the user to view a command activated by the rotation of the device.

In order to obtain this homogenous illumination, it is possible to use as many light sources as there are possible positions for the light index. However, the use of a large number of light sources presents implementation difficulties, in particular in terms of spatial requirement and power supply.

One existing solution consists in using a light collector illuminated by one or more light sources. The light collector has a circular shape and is connected with the light index. Such devices allow illumination of the index to be obtained by limiting the light source number.

However, these devices have faults with regard to connection between the light collector and the light index. Therefore, the visual rendition for the user is not homogenous. In particular, the light intensity of the light index is not seen to be identical according to the various positions of the light index.

Therefore, it is necessary to provide a lighting device allowing homogenous illumination of the light index while having a reduced number of light sources.

The invention therefore proposes a lighting device comprising:

at least one light source,

a light collector,

two light-gathering guides linked with the light collector, characterized in that

the light collector is shaped such as to lead a light beam coming from said at least one light source into the two light-gathering guides,

each of the gathering guides is provided with an input end that tangentially penetrates the light collector, and with an output end, and

the two gathering guides are shaped such that the two output ends come together, forming an output refracting surface of the lighting device.

Advantageously, the configuration of the gathering guides of the lighting device according to the invention allows homogenous illumination to be obtained at the output ends of the gathering guides.

In particular, since the input ends of the gathering guides tangentially penetrate the collector, the connection between these guides and the collector is greatly improved.

The device according to the invention can also comprise one or more of the features below, considered individually or using all of the combinations technically possible:

the light collector is a ring-type light collector; and/or

the light collector has a circular section; and/or

the light collector is configured such that R>4.5×d3, where R is the inner radius of the light collector and d3 is the diameter of the section of the collector; and/or

the collector comprises a leveled surface arranged facing said at least one light source; and/or

the leveled surface of the collector comprises prism-shaped dispersing elements; and/or

the prisms are radial to the collector; and/or

the prisms have an apex angle of 90°; and/or

the gathering guides extend in a direction substantially perpendicular to the mid-plane of the light collector; and/or

the gathering guides have circular sections; and/or

the circular sections of the gathering guides substantially have the same diameter; and/or

the diameters of the gathering guides are less than the diameter of the light collector; and/or

the radius of curvature of the gathering guides at the input ends thereof is greater than 4.5 times the diameter of the section of the collector; and/or

said at least one light source comprises at least one light-emitting diode arranged opposite the light collector; and/or

the light collector and the gathering guides are formed from a single piece.

The invention also relates to an indicator light particularly intended for a control panel of a motor vehicle comprising a lighting device according to the invention.

The invention further relates to a motor vehicle control panel having a man-machine interface comprising a lighting device according to the invention.

The invention will be better understood in light of the following description which is only given indicatively without the intention of limiting the invention, accompanied by the figures below:

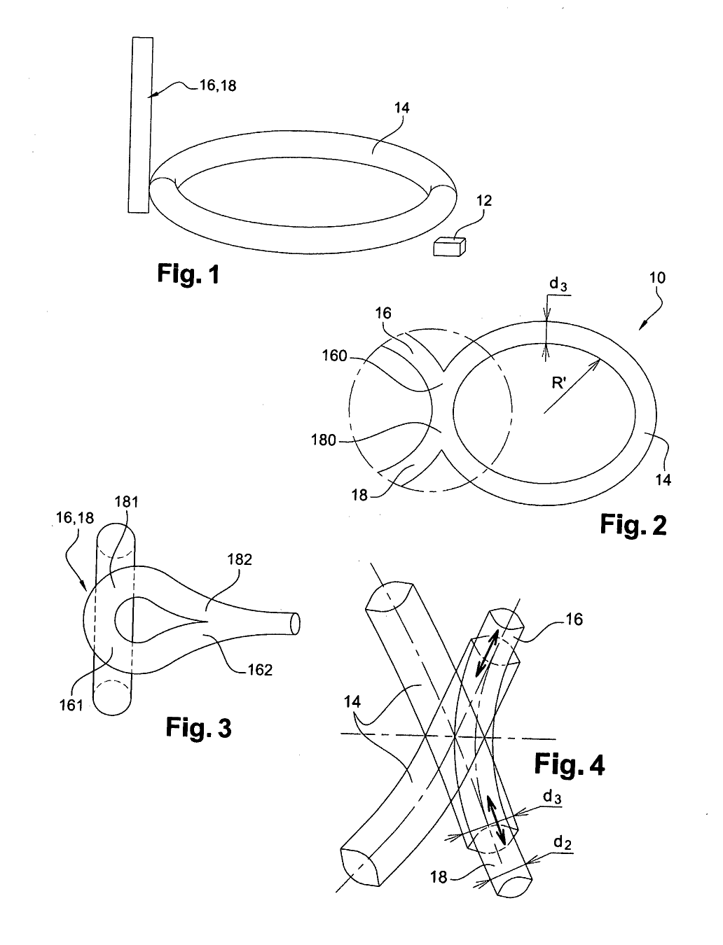

FIG. 1 is a schematic representation of a lighting device according to the invention,

FIG. 2 is a top view of a lighting device according to the invention,

FIGS. 3 and 4 illustrate the gathering guides of a device according to the invention,

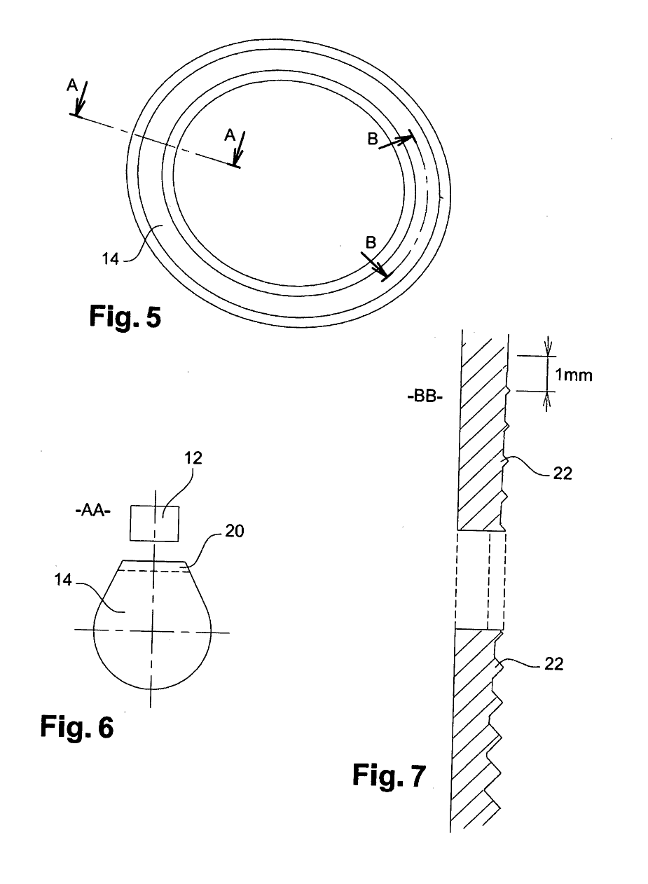

FIG. 5 is a top view of a device according to the invention,

FIG. 6 is a section along the axis AA of the device of FIG. 5, and

FIG. 7 is a section along the axis BB of the device of FIG. 5.

As illustrated in FIGS. 1 and 2, the invention relates to a lighting device 10 comprising a light collector 14 and two light-gathering guides 16 and 18 linked with the light collector 14.

The light collector is shaped such as to lead a light beam coming from the light source 12 into the light-gathering guides 16 and 18.

In this case, the light source 12 comprises one or more light-emitting diodes, arranged, for example, on a PCB supporting means, in particular an insulated metal substrate supporting means.

The light collector 14 and the two gathering guides 16 and 18 are preferably formed from a single piece. Therefore, the light rays propagate naturally by total reflection inside the light collector 14 firstly, then inside the gathering guides subsequently, without an obstacle or separation between the parts of the collector and the gathering guides which could be detrimental to the flow thereof.

As shown in the figures, the light collector 14 has a rotational symmetry and the light source 12 is placed at the light collector 14. Advantageously, the light collector can, therefore, be rotated about the symmetry axis thereof and still be arranged facing the light source 12.

Advantageously, the light collector 14 can be a ring-type collector and has a circular section such that a maximum amount of light rays propagating in the light collector 14 is totally reflected, therefore maintaining a maximum amount of light rays in the light collector.

The light collector is not limited to a circular section. It can have a square, rectangular or oval section. However, these shapes are less favorable than a circular section promoting a total reflection of the rays propagating in the light collector.

In the case of a circular section and in order to keep a maximum intensity of the light beam and prevent the losses, the light collector is configured such that R>4.5×d3, where R is the inner radius of the light collector and d3 is the diameter of the section of the collector.

Preferably, as illustrated in FIG. 6, the light collector 14 comprises a leveled surface 20 arranged on the side of the light source 12. Advantageously, the presence of the leveled surface 20 allows a maximum amount of light rays coming from the light source 12 to penetrate the light collector 14.

As shown in FIG. 7, the leveled surface 20 can advantageously comprise prism-shaped dispersing elements 22. The dispersing elements 22 allow the number of light rays coming from the light source 12 penetrating the light collector 14 to be further increased.

The prisms forming the dispersing elements 22 are preferably radial to the collector and have an apex angle of approximately 90°.

The light collector 14 further comprises gathering points 160, 180 corresponding to the input point of the gathering guides 16 and 18 in the light collector 14.

The further away the light source 12 is from said gathering points 160, 180, the more it is necessary to input light rays coming from the light source 12 into the light collector 14. Indeed, the light rays must circle in the light collector 14 in order to meet the gathering points 160 and 180. Therefore, since the losses are non-zero losses, the further away the input point is from the gathering points, the greater are the losses of intensity.

To take into account this constraint, the prisms making up the dispersing elements 22 have different depths depending on the distance thereof to the gathering points 160 and 180. The greater the distance from the gathering points 160 and 180, the deeper are the prisms. According to an embodiment, the distance between two adjacent prism apexes is approximately 1 mm.

The prisms forming dispersing elements 22 are configured such as to allow the light rays coming from outside the light collector 14 to penetrate said light collector 14 and such as to reflect the light rays propagating in the light collector 14. Advantageously, the light rays having entered the light collector are trapped in said collector 14. Through successive reflections, said light rays are brought to propagate in the collector 14 up to the gathering points 160 and 180.

As illustrated in FIGS. 2 and 4, the gathering guides 16 and 18 are provided with an input end 161 and 181 and with an output end 162 and 182. The two gathering guides 16 and 18 are shaped such that the two output ends 162 and 182 come together, therefore forming an output refracting surface of the lighting device according to the invention.

The input ends of the gathering guides 161 and 181 tangentially penetrate the light collector 14 at the gathering points 160 and 180.

The gathering guides are configured such that the angle of incidence and the curvature of the gathering guides promote the total reflection of the light rays coming from the light collector in the gathering guides.

Therefore, the light rays exiting the light collector 14 propagate in the gathering guides from the input end thereof 161 and 162 toward the output ends 162 and 182 by total reflection.

Preferably, the gathering guides 16 and 18 have circular sections with a diameter substantially equal to and less than the diameter of the circular section of the light collector 14. The main axis of each of the gathering guides 16 and 18 is substantially parallel to the main axis of the light collector 14 at the gathering points 160 and 180.

According to an embodiment of the invention, the radius of curvature of the gathering guides 16 and 18 at the input ends thereof is greater than 4.5 times the diameter of the section of the ring-type collector 14. Advantageously, such a configuration promotes the propagation of the light rays in the lighting device according to the invention.

As illustrated in FIG. 3, the gathering points form a “Y” with the two light-gathering guides allowing the light rays propagating in both directions in the light collector to be recovered.

Advantageously, the configuration of the lighting device according to the invention as shown in the figures allows it to be used as a light index. Indeed, the light collector 14 and the gathering guides 16 and 18 can be rotated about the symmetry axis of the collector 14, with the source 12 remaining fixed.

To allow the lighting device according to the invention to be used as a rotating light index, the gathering guides 16 and 18 extend in a direction substantially perpendicular to the mid-plane of the light collector 14.

Such a configuration of the lighting device allows good homogenization of the light beams at the output ends 162 and 182 of the gathering guides.

According to an embodiment, the output ends of the gathering guides can comprise light dispersing elements (not shown) allowing the number of light rays exiting the lighting device at the output ends of the gathering guides to be increased.

The invention also relates to an indicator light particularly intended for a control panel of a motor vehicle comprising a lighting device 10 according to the invention and a motor vehicle control panel having a man-machine interface comprising a lighting device according to the invention.

Finally, it is understood that many adjustments of the lighting device 10 according to the invention, which device has been described in detail above, can be introduced, while keeping at least some of the advantages of the invention.

1. A lighting device comprising:
at least one light source,
a light collector,
two light-gathering guides linked with the light collector,
characterized in that
the light collector is shaped such as to lead a light beam coming from said at least one light source into the two light-gathering guides,
each of the light-gathering guides is provided with an input end that tangentially penetrates the light collector, and with an output end, and
the two light-gathering guides are shaped such that the two output ends come together, forming an output refracting surface of the lighting device.

2. The lighting device as claimed in claim 1, wherein the light collector is a ring-type light collector.

3. The lighting device as claimed in claim 1, wherein the light collector has a circular section.

4. The lighting device as claimed in claim 3, wherein the light collector is configured such that R>4.5×d3, where R is the inner radius of the light collector and d3 is the diameter of the section of the light collector.

5. The lighting device as claimed in claim 1, wherein the light collector comprises a leveled surface arranged facing said at least one light source.

6. The lighting device as claimed in claim 5, wherein the leveled surface of the light collector comprises prism-shaped dispersing elements.

7. The lighting device as claimed in claim 6, wherein the prisms are radial to the light collector.

8. The lighting device as claimed in claim 1, wherein the prisms have an apex angle of 90°.

9. The lighting device as claimed in claim 1, wherein the light gathering guides extend in a direction substantially perpendicular to the mid-plane of the light collector.

10. The lighting device as claimed in claim 1, wherein the light-gathering guides have circular sections.

11. The lighting device as claimed in claim 10, wherein the circular sections of the light-gathering guides substantially have the same diameter.

12. The lighting device as claimed in claim 10, wherein the diameters of the light-gathering guides are less than the diameter of the light collector.

13. The lighting device as claimed in claim 3, wherein the radius of curvature of the light-gathering guides at the input ends thereof is greater than 4.5 times the diameter of the section of the light-collector.

14. The device as claimed in claim 1, wherein said at least one light source comprises at least one light-emitting diode arranged opposite the light collector.

15. The lighting device as claimed in claim 1, wherein the light collector and the light-gathering guides are formed from a single piece.

16. An indicator light particularly intended for a control panel of a motor vehicle comprising a lighting device as claimed in claim 1.

17. A motor vehicle control panel having a man-machine interface comprising a lighting device as claimed in claim 1.
